(19) United States
(12) Patent Application Publication
(10) Pub. No.: US 2007/0008297 A1
(43) Pub. Date: Jan. 11, 2007

(54) Method and apparatus for image based power control of drive circuitry of a display pixel

(76) Inventor: Chester Floyd Bassetti, Reno, NV (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/407,785

(22) Filed: Apr. 19, 2006

Related U.S. Application Data
(60) Provisional application No. 60/674,672, filed on Apr. 20, 2005.

(51) Int. Cl. G09G 5/00

(52) U.S. Cl. 345/173

(57) ABSTRACT

An apparatus and a method for controllably reducing power and heat dissipated by OLED display circuitry are disclosed. Image dependent drive voltage adjustments are made to reduce the power generated by and the heat dissipated by the OLED pixel circuitry. That extends the life span of the components of the OLED pixel circuitry and maintains their quality by reducing or eliminating the degradation caused by heat. The apparatus and the method of the present invention selectively reduce the voltage level provided to the drain of the transistor used to drive the OLED. The drive transistor's drain voltage level is controllably lowered during display intervals that require less than the brightest level of illumination.

### RELATED APPLICATION

The present application claims priority to the U.S. Provisional Patent Application No. 60/674,672, filed on Apr. 20, 2005.

### FIELD OF INVENTION

This invention relates to flat panel displays and more specifically to Organic Light Emitting Diode (OLED) type displays.

### BACKGROUND OF THE INVENTION

Flat panel displays including plasma, electroluminescent (EL), organic light emitting diode (OLED) and liquid crystal displays are used in a variety of products ranging from cell phones and personal digital assistants (PDA) to computers and televisions. Active Matrix Liquid Crystal Displays (AMLCD) are known in the art. In the active matrix displays, the row driver and the column driver are used to control the OLED pixel, and a capacitor is used to continue to drive the pixel when the drivers are not driving the pixel because they are driving other pixels. The AMLCD can produce about 16 million different colors by carefully controlling the voltages provided to each addressable pixel of the display by using digital to analog (D/A) converters on each display column.

Active matrix OLED (AMOLED) are being developed and have shown promise to surpass the AMLCD because features such as the viewing angle, response time and power consumption are vastly improved in the AMOLED displays. However, a major problem with the OLED displays is that the OLED display elements degrade over time and output progressively less light. A factor which contributes to this degradation of the OLED display components is the heat dissipated by the circuitry that drives the OLED.

The schematic in FIG. 1 shows an example of the drive scheme presently employed for the sub-pixel 100 in an exemplary color AMOLED display. Three such sub-pixels 100 (one each for Red, Green, and Blue) are required for a color display. The drive voltage is supplied by the column driver integrated circuit (IC) chip (not shown), which applies a voltage to the drain of transistor T1. That voltage can be referred to as V_{Data} and is passed through T1 to the gate of the transistor T2 when the row driver voltage (referred to as V_{enable}) is asserted or raised to an on condition.

Brightness levels (for example 256 brightness levels for each RGB sub-pixel) are controlled by varying the voltage of the column driver, which in turn controls the voltage to the gate of T2, which then supplies current through T2 to energize the OLED to emit the desired brightness. The gate voltage of T2 is held by capacitor C1 so that when the row driver voltage is not asserted or switched to the off condition (in order to drive the next row of the display), T2 continues to drive the OLED at the desired brightness level.

Voltage V_{DD} connected to the drain of T2 is usually set to a high value to supply adequate levels for anticipated maximum brightness levels. In the present art, when low brightness levels are required (based on the displayed image), voltage V_{DD} remains the same. As a result, excess voltage appears across the drain-source junction of transistor T2 and heat is generated as the result of the power that is dissipated, which is equal to the product of the current flowing through T2 and the voltage drop across the drain-source junction of transistor T2. That heat is undesirable because it results in the degradation of the components located near T2.

### SUMMARY OF THE INVENTION

The present invention relates to methods and apparatus for displaying an image having one or more frames. The display can be an organic light emitting diode (OLED) display. The display includes an active matrix of pixels including OLED circuitry. The display also includes a voltage source for providing a voltage to the OLED driver and a detection circuit for determining the maximum brightness level associated with an image frame. A control circuit for adjusting the voltage provided to the OLED driver according to the maximum brightness level determined by the detection circuit is also provided.

A thin film transistor (TFT) is used to couple the voltage source to the OLED and drive the OLED. At least enough voltage is provided by the voltage source to ensure that the TFT operates in the saturation mode and thereby acts as a current source for the OLED.

Many embodiments of the invention are disclosed in the specification. One of ordinary skill in the art will appreciate that other embodiments are possible without deviating from the scope and spirit of the invention.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates a schematic of a drive scheme for a sub-pixel in an active matrix OLED display;

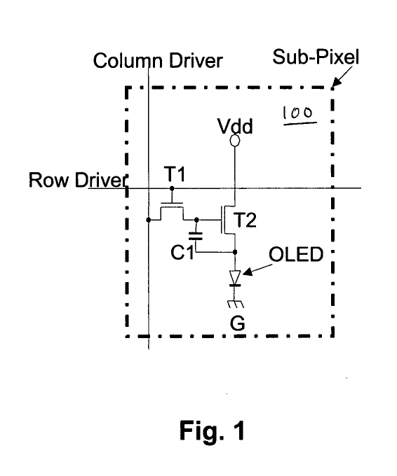

FIG. 2 illustrates an expanded schematic of a current source for an OLED;

FIG. 3 graphically illustrates the relationship between the current flowing through the OLED drive transistor and the voltage across the OLED drive transistor for two different gate voltages applied to the OLED drive transistor;

FIG. 4 illustrates an exemplary histogram of pixel brightness in an image to be displayed;

FIG. 5 graphically illustrates the relationship between the brightness of the light emitted by the OLED and the gate voltage applied to the OLED drive transistor;

FIG. 6 graphically illustrates the relationships between brightness, voltages, powers and currents associated with the OLED and the OLED drive transistor;

FIG. 7 illustrates an exemplary block diagram of the display system of the present invention;

FIG. 8 illustrates another exemplary block diagram of the display system of the present invention;

FIG. 9 illustrates another exemplary block diagram of the display system of the present invention;

FIG. 10 illustrates another exemplary block diagram of the display system of the present invention; and

FIG. 11 illustrates another exemplary block diagram of the display system of the present invention.

### DETAILED DESCRIPTION OF THE INVENTION

The present invention provides apparatus and methods to control and the reduce power provided to the OLED through T2 and thus reduces the heat dissipated by T2, thereby improving OLED life and preventing the degradation of the OLED circuitry elements. The power consumption of the OLED is minimized by reducing the OLED drive transistor drain voltage during display intervals that require less than full-scale worst case illumination. By reducing V_{DD} when displaying dim brightness levels, the power and heat generated across T2 are reduced and that increases the OLED lifetime.

The V_{DD} supply is common to all sub-pixels and pixels of the display. Because one sub-pixel could be displaying a dim brightness level while another sub-pixel displays a high brightness level, lowering the V_{DD} for dim sub-pixels is not feasible in a system in which V_{DD} is common to all sub-pixels. Therefore, the present invention uses a multiplexor associated with each pixel or sub-pixel to adjust the voltage only for that pixel or sub-pixel.

OLED materials are current driven. That is, the brightness level of the light emitted by the OLED is determined by the current level passing through the OLED. Although a voltage appears across the OLED when a specific current is flowing through the OLED, this voltage is not the direct cause of the photon emission. The current level is the therefore controlling factor because the light emission from the OLED is due to the recombination of holes and electrons which are supplied by the current flow (electrons entering the OLED from the cathode side and holes entering from the anode side).

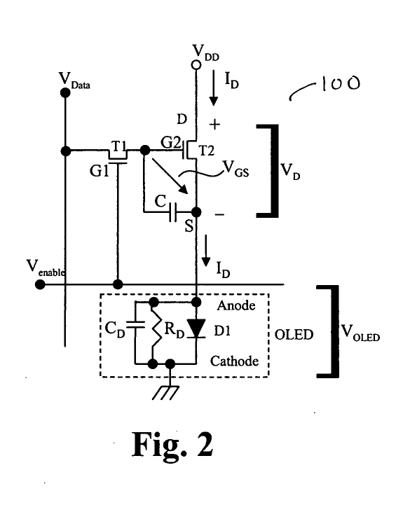

The current flowing through the OLED is controlled by the thin film transistor (TFT) T2. In order to have optimum current control, TFT T2 is biased in the saturation mode. FIG. 2 is a detailed schematic of the OLED driver circuitry for the OLED D1. During operation, the line V_{Data} supplies a voltage to the gate of T2 though T1, when T1 is enabled by a high voltage supplied by the V_{enable} line. When the V_{enable} becomes low, the data voltage V_{Data} is retained on the gate of T2 by capacitor C.

The current ID, which flows through T2 and D1 is proportional to V_{Data}. The power dissipated in the circuit comprised of T2 and D1 is the product of ID and V_{DD}. V_{DD} is proportioned between T2 and D1. In FIG. 2, the voltage across T2 is designated by V_{D} and the voltage across D1 is designated V_{OLED}. The relationship between V_{DD}, V_{D} and V_{OLED} is defined as: V_{DD}=V_{D+V}_{OLED}. The power dissipated in T2 is the product of I_{D} and V_{D}. Any power dissipated in T2 is not only wasted power but it also causes OLED D1 to heat up thereby shortening the life of D1. Therefore, it is beneficial to reduce the voltage drop V_{D} to a minimum.

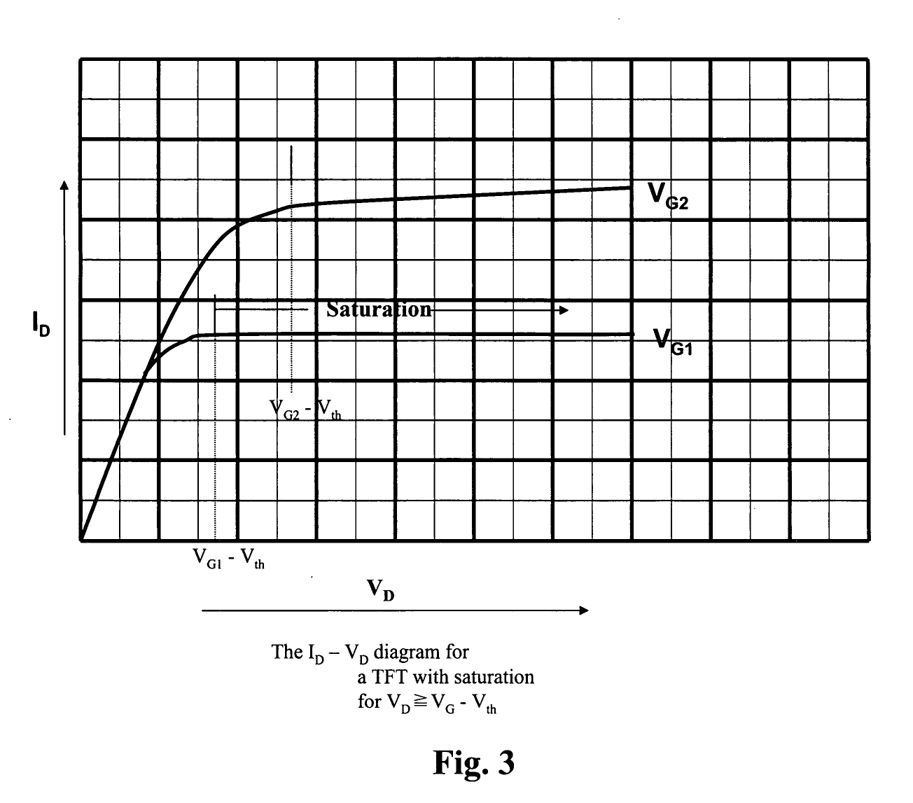

Referring to FIG. 3, the graph shows the relationship between the I_{D} (y axis) and the V_{D} (x axis) for different levels of voltages applied to the gate of T2 (V_{G1} and V_{G2}). V_{D} is shown to be V_{G}−Vₜₕ, where Vₜₕ is the threshold voltage of the TFT T2. For T2 to be in saturation, and thus, a current generator, the relationship between V_{DD}, V_{G} and Vₜₕ must be: V_{DD}>=V_{G}−Vₜₕ. One of ordinary skill in the art would appreciate that a lesser level of V_{DD} would be required if V_{G1} is applied to T2 than if V_{G2} were applied to T2. It follows that the greater the current level required by the OLED, the higher V_{DD} level that must be applied to maintain T2 as a current generator.

One of ordinary skill in the art would appreciate that in practice Vₜₕ is not completely stable and can increase over the life of the OLED. OLED materials also increase in resistance and decrease in quantum efficiency as they age. To compensate for the increase in voltage requirements over the life of the display, V_{DD} is set to a high value and therefore, a high percentage of the total power (I_{D}×V_{DD}) is wasted in T2 due to excessive V_{D}. The present invention solves the problem of wasted power dissipation due to excessive voltage across T2. One of ordinary skill will appreciate from FIG. 3 that T2 can be in saturation for a wide range of V_{DD} values.

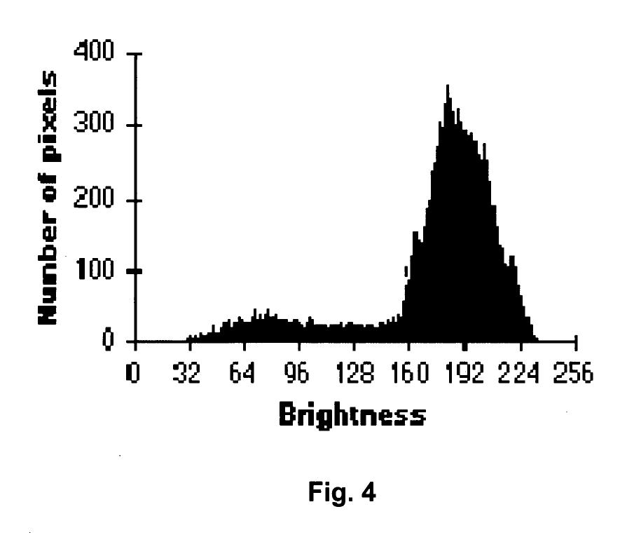

Display images vary dramatically based on their application. Over the entire life of a display the images will sometimes be bright, dark or in between. A histogram like the one shown in FIG. 4 plots the number of pixels that are displaying brightness settings 0-255. This exemplary histogram for a specific image shows no pixels are illuminating above about the brightness setting of 232. In the case of this image, the maximum current requirement for the brightest pixels in the image is less than full brightness requirement. Therefore, the required maximum gate voltage for T2 is lower, and thus, V_{DD} can be reduced without T2 falling out of saturation. The V_{DD} will result in reduced power and heat production and increased OLED life.

In an 8 bit color system, each color has 0 to 255 steps of brightness. One of ordinary skill in the art will appreciate that the human eye response is logarithmic and thus the 255 steps are not linear but instead follow a logarithmic scale. Therefore, the 50% intensity point of OLED emission is at approximately data setting 181 (step 181). The data setting of 232 produces a brightness of about 82%. The more pictures or video frames that fall into the “reduced drive voltage” mode, the greater occurrences of power saving which in turn leads to longer OLED life, if the apparatus and methods of the present invention are used.

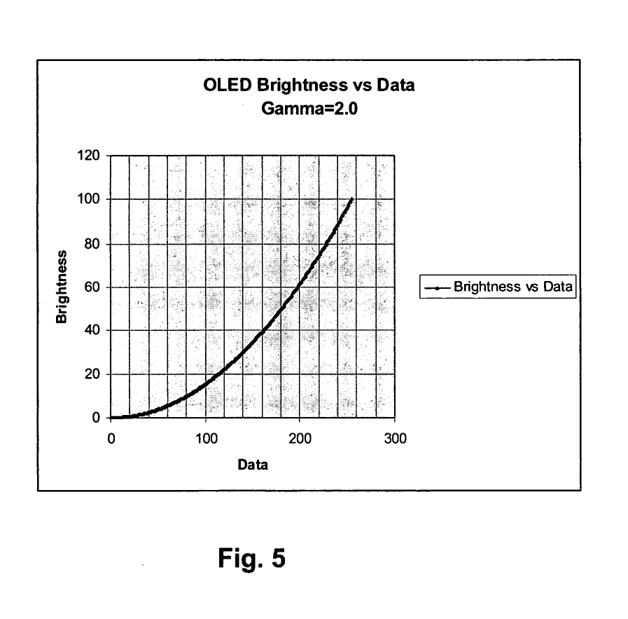

FIG. 5 shows the relationship between the OLED brightness (y axis) and the V_{Data} (w axis), which is provided to the gate of T2 through T1. As shown in FIG. 5, the higher the voltage that is applied to the gate of T2, the higher the light emitted by the OLED.

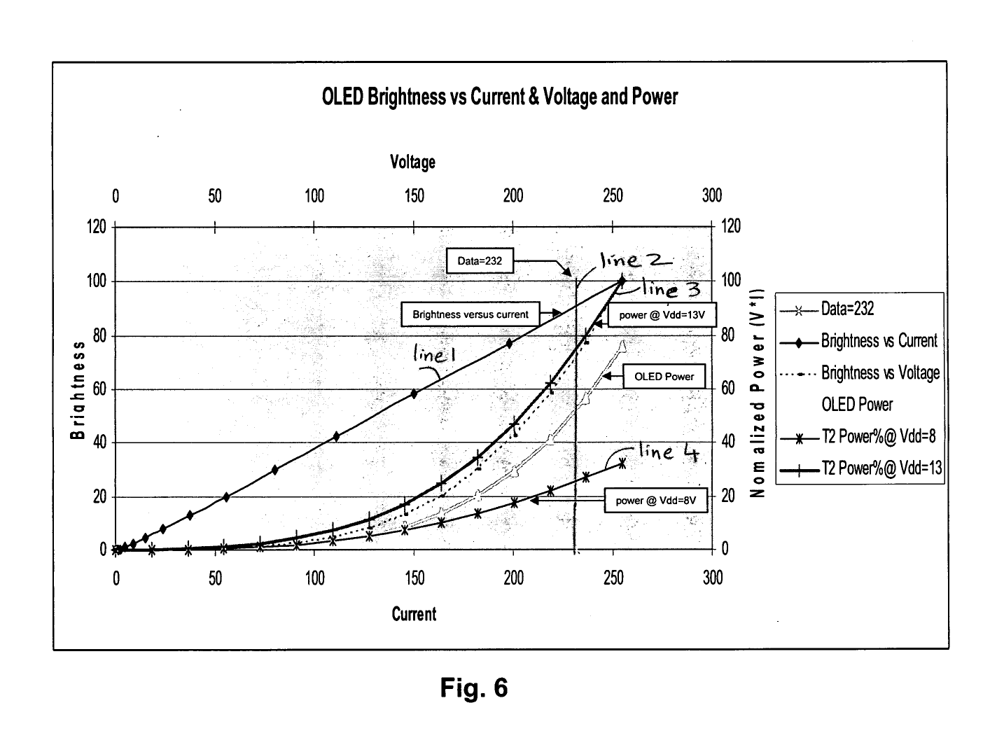

Referring to FIG. 6, several characteristics of an exemplary display system of the present invention are shown, in which no pixels have a brightness level above 232 (line 2). Line 1 illustrates that the level of the current flowing through the OLED and the level of brightness of the OLED are directly proportional. Lines 3 and 4 show the power dissipated by T2 for two different exemplary V_{DD} voltages, 13 volts and 8 volts respectively. As can be seen from lines 3 and 4, dropping the voltage V_{DD} from 13 v to 8 v reduces the power dissipation in transistor T2 from about 75% to about 25%. This 66.7% power reduction leads to less heat and therefore longer OLED life.

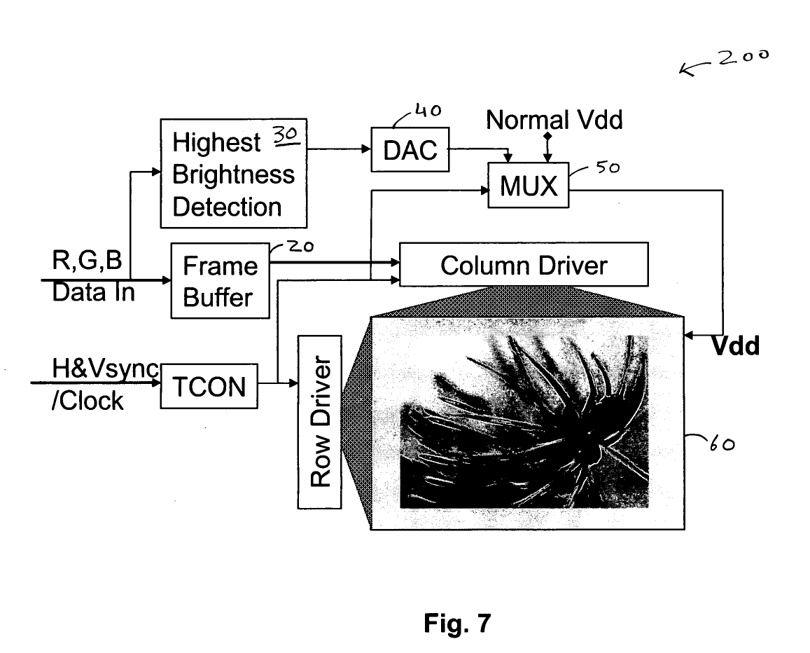

FIG. 7 illustrates an embodiment of the OLED display system of the present invention. The OLED display system includes the row driver and the column driver for driving the display 60 pixels, which are well known in the art. The highest brightness detection circuit 30 is coupled to the digital to analog circuit 40, which in turn is coupled to the multiplexor 50. The OLED display system 200 includes a frame buffer 20 to store the RGB image. The data coming into the frame buffer 20 memory is screened for the highest brightness setting for each RGB input by the highest brightness detection circuit 30. V_{DD} is then altered to accommodate only the highest brightness setting for the frame, which will be used on the next display period, and is synchronized with the buffer memory. The digital to analog converter circuit 40 is used to convert the highest brightness setting detected by the detection circuit 30 into a voltage value. The multiplexor 50 is then used to provide a proper portion of the V_{DD} to the pixel or sub-pixel.

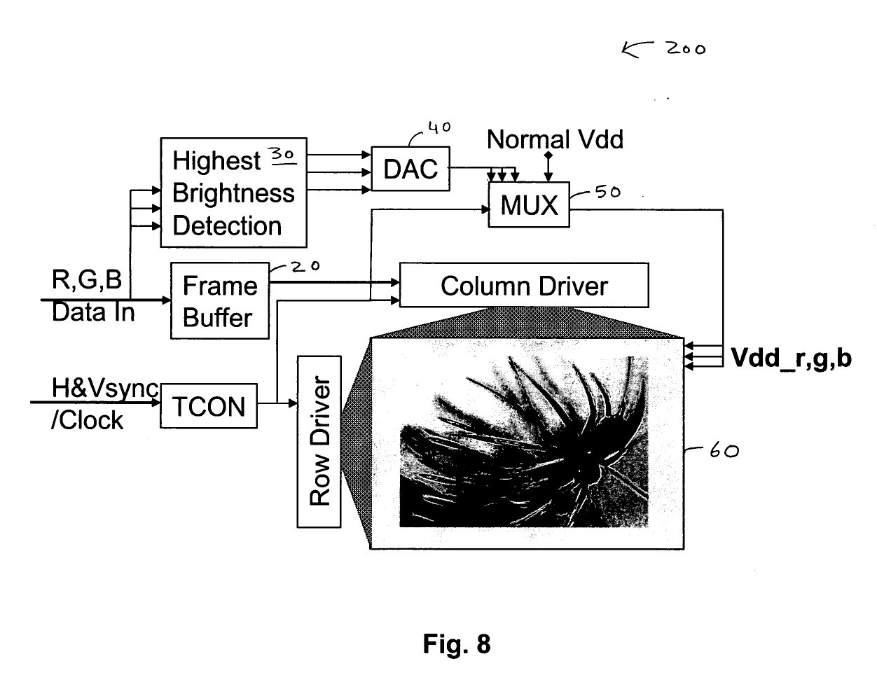

FIG. 8 illustrates another embodiment of the OLED display system of the present invention. Unlike typical OLED displays that have one global V_{DD} connection to all pixels and all sub_pixels, in this embodiment a separate V_{DD} connection is used for each color such as V_{DD}_{_{—}}R (red), V_{DD}_{_{—}}G (Green), V_{DD}_{_{—}}B (Blue) and V_{DD}_{_{—}}W (white).

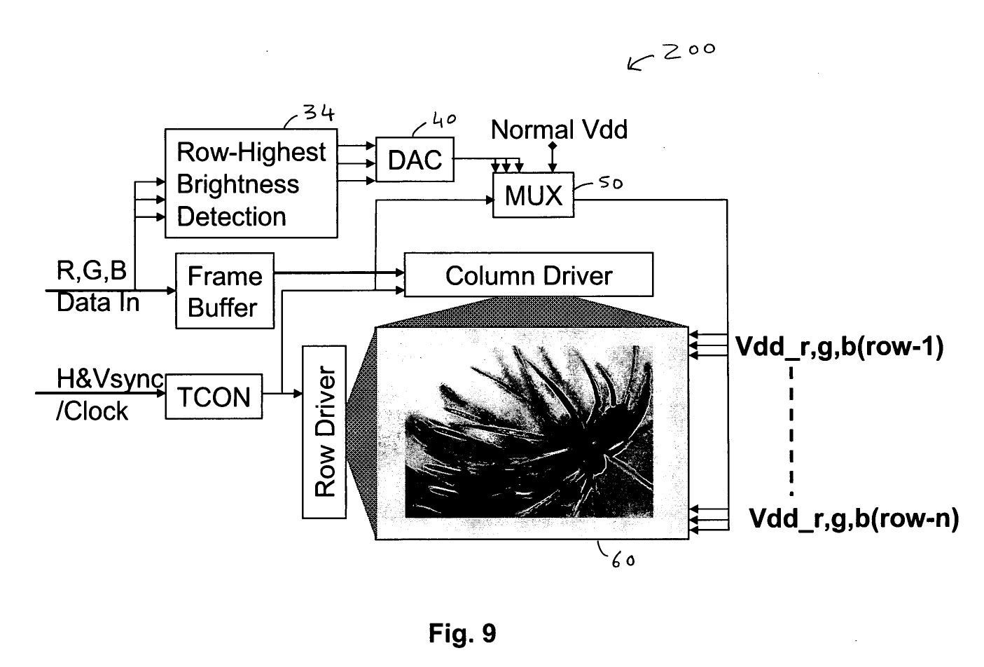

FIG. 9 illustrates another embodiment of the OLED display system of the present invention. One issue that arises is that the new V_{DD} value when presented will affect the image currently being displayed on the OLED screen, because the OLED retains the image until re-written. To solve this problem, V_{DD} is split into rows. A multiplexor (MUX) is used for each row to select between V_{DD} (frame_n) and V_{DD} (frame_n+1). The new V_{DD} value will be presented on a row by row basis as the maximum brightness for each row. In this embodiment, the highest brightness detection circuit 30 is replaced by the row-highest brightness detection circuit 34 for detecting the highest brightness setting for each row of display pixels instead of the highest brightness setting for the entire pixel.

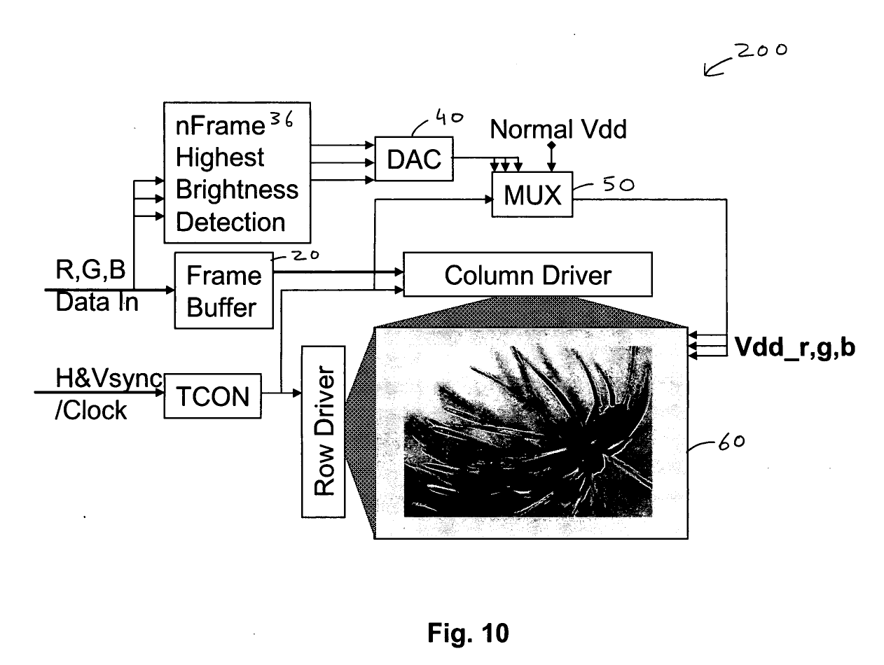

FIG. 10 illustrates another embodiment of the OLED display system of the present invention. In this embodiment, the change of V_{DD} occurs after n-successive frames. The nFrame highest brightness detection 36 detects the highest brightness setting only for selected frames of the image. The highest value for the V_{DD} will then be used and when a higher value is sensed incoming, the V_{DD} will use the new value immediately (i.e. switching to a higher value will not affect image brightness). This scheme will reduce voltage to V_{DD} conservatively (as the display has shown n frames of reduced maximum brightness levels) and switch back quickly without affecting the image brightness.

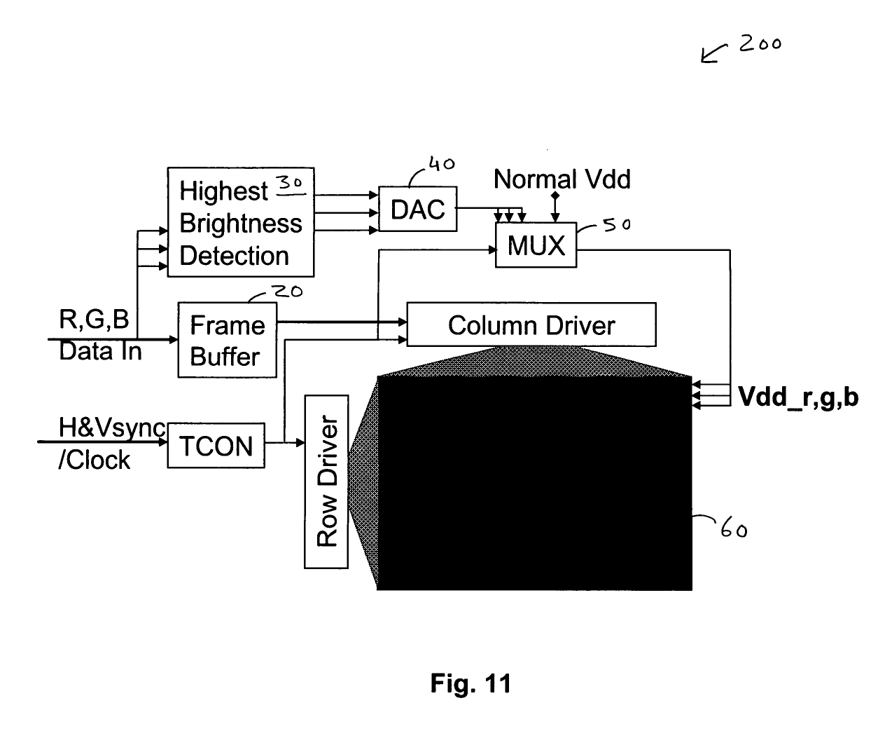

FIG. 11 illustrates another embodiment of the OLED display system of the present invention. In this embodiment, the V_{DD} is switched during an intermediate black frame.

1. A display comprising:
an image including one or more frames to be displayed on the display;
a plurality of pixels for displaying the image frames;
a voltage source for providing a voltage to a light emitting element of a pixel of the plurality of pixels;
a detection circuit for determining the maximum brightness level associated with an image frame; and
a control circuit for adjusting the voltage provided to the light emitting element according to the maximum brightness level determined by the detection circuit.

2. The display of claim 1, wherein the light emitting element includes an organic light emitting diode.

3. The display of claim 1, further comprising:
the voltage source is coupled to the light emitting element by a thin film transistor (TFT).

4. The display of claim 3, wherein the thin film transistor (TFT) provides a current source for the light emitting element.

5. The display of claim 3, wherein the control circuit causes voltage source to provide at least the level of voltage required to cause the thin film transistor to operate in the saturation mode.

6. The display of claim 1, wherein the display includes an active matrix of light emitting elements.

7. The display of claim 1, further comprising:
the pixel including a plurality of sub-pixels;
each of the plurality of sub-pixels including a light emitting element;
the voltage source for providing a voltage to a light emitting element of a sub-pixel of the plurality of sub-pixels; and
a second voltage source for providing a voltage to a light emitting element of another sub-pixel of the plurality of sub-pixels; wherein,
each sub-pixel is associated with a different color;
the detection circuit for determining the maximum brightness level associated with each sub-pixel; and
the control circuit for adjusting the voltage provided to the light emitting element of each sub-pixel according to the maximum brightness level for each sub-pixel determined by the detection circuit.

8. The display of claim 1, wherein the detection circuit for determining the maximum brightness level and the control circuit for adjusting the voltage provided only for the selected frames of the image.

9. The display of claim 1, wherein the detection circuit for determining the maximum brightness level and the control circuit for adjusting the voltage provided only for the frame of the image that follows a black frame.

10. A display comprising:
an image including one or more frames for display;
a first row of pixels;
a second row of pixels;
each pixel of the first row of pixels including a set of a plurality of sub-pixels, each of the sub-pixels of the set associated with a different color;
each pixel of the second row of pixels including a set of a plurality of sub-pixels, each of sub-pixels of the set associated with a different color;
a detection circuit for determining the maximum brightness level associated with each color for the first row;
the detection circuit for determining the maximum brightness level associated with each color for the second row; and
a control circuit for adjusting the voltage provided a light emitting elements of each sub-pixel according to the maximum brightness level for each color determined by the detection circuit.

11. The display of claim 10, wherein the display includes an active matrix of organic light emitting diodes.

12. The display of claim 10, wherein the set of the plurality of sub-pixels includes three sub-pixels.

13. The display of claim 1 1, wherein the each of the three sub-pixels is associated with red, blue or green color.

14. A method for a display comprising:
determining the maximum brightness level for a frame of an image to be displayed; and
adjusting the voltage level provided to a pixel of the display according to the determination of the maximum brightness level.

15. The method of claim 14, wherein adjusting the voltage level including lowering the voltage level if the determined maximum brightness level for the frame is less that the determined maximum brightness level of a previous frame.

16. The method claim 14, wherein providing the voltage to the drain of a thin film transistor used for driving a light emitting element of the display.

17. The method of claim 16, wherein providing at least enough voltage level to the drain of the thin film transistor to cause the transistor to operate in the saturation mode.

18. The method of claim 17, wherein providing the voltage to the drain of the thin film transistor to cause the transistor to act as a current source for the light emitting element.

19. The method of claim 14, further comprising:
performing the determining and adjusting steps separately for a plurality of rows of pixels of the display.

20. The method of claim 14, further comprising:
performing the determining and adjusting steps only for selected frames of the image.
